(19) United States
(12) Patent Application Publication
(10) Pub. No.: US 2026/0326138 A1
(43) Pub. Date: Oct. 22, 2026

(54) HOLDER FOR DRYWALL TEXTURING GUN

(71) Applicant: Eldon Dunstan, Mankato, KS (US)

(72) Inventor: Eldon Dunstan, Mankato, KS (US)

(21) Appl. No.: 19/653,777

(22) Filed: Apr. 21, 2026

Related U.S. Application Data
(60) Provisional application No. 63/792,259, filed on Apr. 21, 2025.

(51) Int. Cl. B05B 15/62

(52) U.S. Cl. CPC B05B 15/62

(57) ABSTRACT

A holder for a drywall texturing gun includes a base structure, a rack removably mounted to the base structure, and a receptacle configured to receive a handle of the drywall texturing gun. The rack has upright support members and first and second horizontal support members and is reversible end-for-end relative to the base structure so that different ones of the horizontal support members are positioned to support the gun in different orientations. The reversible design allows the holder to adapt to wall and ceiling spraying configurations and accommodate a variety of drywall texture gun types. The rack and receptacle may be removed and stowed within the base structure for compact storage and shipping.

### RELATED APPLICATIONS

This application claims the benefit of U.S. Provisional Patent Application No. 63/792,259 filed on Apr. 21, 2025, the contents of which are incorporated herein by reference.

### FIELD OF THE INVENTION

The present invention relates generally to drywall tools and accessories, and more particularly to a holder for a drywall texturing gun that accommodates multiple gun configurations and provides compact storage.

### DESCRIPTION OF THE RELATED ART

Drywall texturing guns are widely used in residential and commercial construction to apply textured finishes to ceilings and walls. These tools are often bulky, awkward to set down, and susceptible to damage or spills when not in use. During short breaks or between applications, a secure and stable resting place is required to hold the gun in a supported position and prevent material leakage or accidental tipping.

Existing solutions for supporting texture sprayers are generally limited in adaptability, may not accommodate varying tool geometries, and often lack portability or efficient stowability. Some supports are permanently assembled, making them cumbersome to transport or ship. Others are fixed in orientation and cannot be adjusted for ceiling versus wall spraying positions.

Furthermore, job site conditions demand durable and weather-resistant construction materials capable of withstanding rough use, while also allowing for rapid disassembly and compact storage.

### SUMMARY OF THE INVENTION

The present invention provides a drywall texturing gun holder that includes a base structure, a reversible metal rack with upright and horizontal support rods, and a handle receptacle. The components are removable and stowable within the base for compact storage. The reversible rack design allows users to support guns in multiple configurations, and when not in use, the components can be nested within the base for streamlined shipping and storage.

### BRIEF DESCRIPTION OF THE DRAWINGS

FIG. 1 is a perspective view of an assembled holder for a drywall texturing gun according to the present invention.

FIG. 2 is a plan view of the assembled holder.

FIG. 3 is an end view of the assembled holder.

FIG. 4 is a side view of the assembled holder.

FIG. 5 is a side view of the assembled holder in a first configuration for supporting a drywall texturing gun used for ceiling texture spraying.

FIG. 6 is a side view of the assembled holder in a second configuration for supporting a drywall texturing gun used for wall texture spraying.

FIG. 7 illustrates the holder in a disassembled configuration for compact storage and shipping.

### DETAILED DESCRIPTION OF THE INVENTION

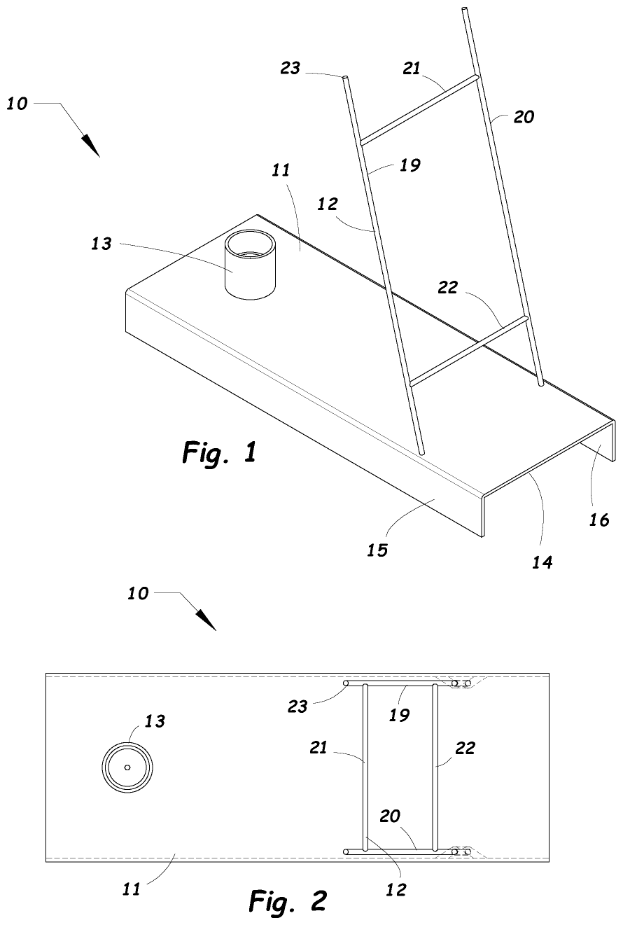

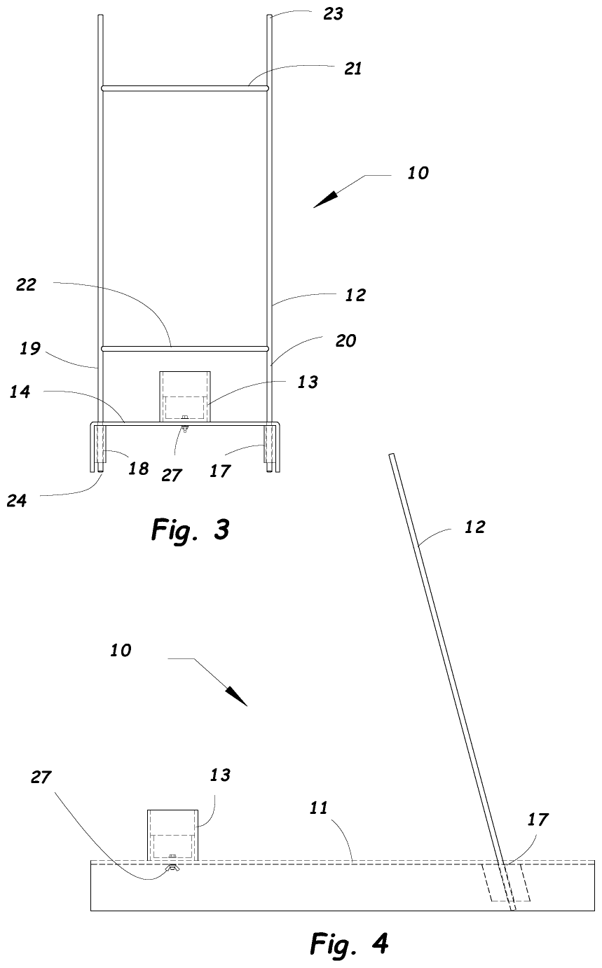

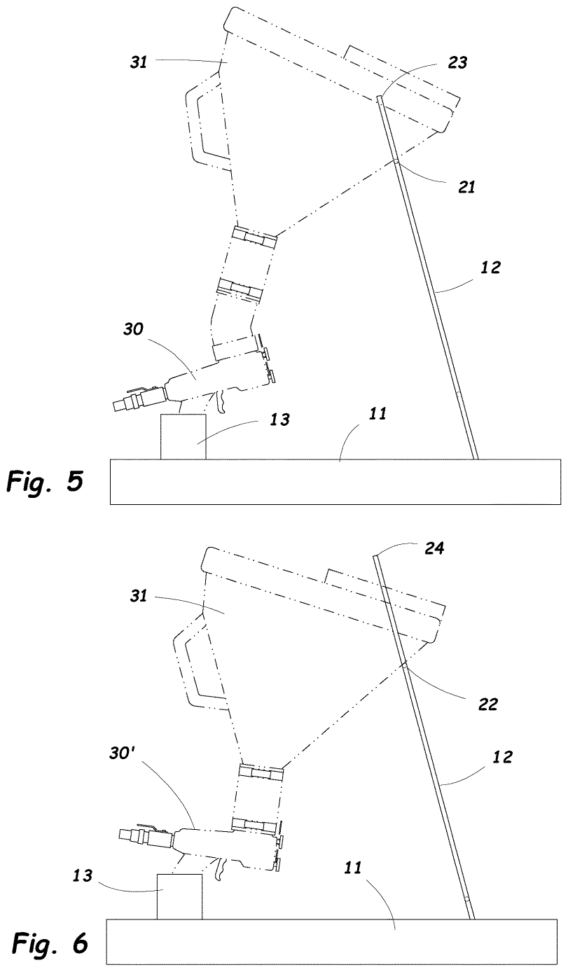

A holder 10 for a drywall texturing gun 30 according to the present invention will be described with reference to FIGS. 1 to 7 of the accompanying drawings.

The holder 10 includes a base structure 11, a rack 12, and a receptacle 13. The base structure 11 is preferably made of molded fiberglass, but plastics, lightweight metals, or other suitable materials may also be used. The base structure 11 may have a channel shape with a planar upper web 14 and downwardly extending flanges 15, 16 on opposite sides.

Tubular sockets 17, 18 are provided in the base structure 11 for receiving and stabilizing upright support members 19, 20 of the rack 12. The tubular sockets 17, 18 may include metal inserts embedded in the molded fiberglass. The sockets extend through the web 14 of the base structure 11 and are secured along the interior faces of the flanges 15, 16. The sockets extend at an angle of approximately 10 to 30 degrees from vertical, and preferably approximately 20 degrees from vertical, so that the rack 12 leans in a direction toward the texturing gun 30 during use to increase the stability of the holder 10.

The rack 12 has two horizontal cross pieces 21, 22 joined to the two upright support members 19, 20. The rack 12 is generally shaped as a ladder with two steps in the form of transverse supports, with the first horizontal support member 21 being located closer to a first end 23 of the rack 12 than the second horizontal support member 22 is located to the second end 24 of the rack 12. The rack 12 is reversible end-for-end, allowing the rack 12 to be secured to the base structure 11 in two different configurations. In one configuration, the first horizontal support member 21 is the upper support and provides a shelf for supporting a hopper 31 of the drywall texturing gun 30. In another configuration, the second horizontal support member 22 is the upper support and provides a shelf for supporting the hopper 31 of the drywall texturing gun 30′.

The two different configurations for securing the rack 12 to the base structure 11 allow the holder 10 to be converted between a first configuration for holding a texturing gun 30 for spraying a ceiling, and a second configuration for holding a texturing gun 30′ for spraying a wall. In particular, the shelf provided by the first horizontal support member 21 in the first configuration is higher than the shelf provided by the second horizontal support member 22 in the second configuration. The higher support position provided by member 21 in the first configuration accommodates the texturing gun 30 when configured for spraying a ceiling, and the lower support position provided by member 22 in the second configuration accommodates the texturing gun 30′ when configured for spraying a wall. In either of these configurations, the upper end portions of the upright support members 19, 20 provide side barriers for the hopper 31 when the gun is held by the holder 10.

Mounted to the base structure 11 is a cylindrical receptacle 13 with an open top and a closed bottom. A bolt or other fastener 26 extends through a hole in the bottom of the receptacle 13 and through a corresponding hole in the base structure 11 to secure the receptacle 13 to the base structure 11. A wing nut 27 can be used with the threaded fastener 26 to facilitate assembly and disassembly. Alternatively, the fastener 26 can be mated with a threaded insert in the web 14 of the base structure 11 to secure the receptacle 13. The receptacle 13 supports the gun handle 28 when the texturing gun 30 is placed on the holder 10.

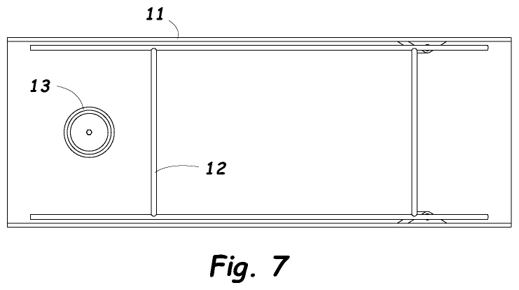

For storage and shipping, the rack 12 and receptacle 13 are easily removable. As shown in FIG. 7, the rack 12 and receptacle 13 may be placed inside the channel defined by the base structure 11, forming a compact, package configuration suitable for storage, transport and shipment. For example, the package configuration of the illustrated embodiment is a rectangular cuboid suitable for packaging in standard shipping boxes.

The invention is not limited to the specific embodiments described herein, and modifications and variations may be made without departing from the scope of the invention as defined by the appended claims.

While the invention has been described in connection with specific embodiments thereof, it is to be understood that this is by way of illustration and not of limitation, and the scope of the appended claims should be construed as broadly as the prior art will permit.

What is claimed is:

1. A holder for a drywall texturing gun, comprising:
a base structure;
a rack having two upright support members and two horizontal support members fixed together to form a single integral unit with legs provided at both ends of the upright support members, said legs being removably inserted into the base structure, and the rack being reversible end-for-end to accommodate different drywall texturing gun configurations; and
a receptacle on the base structure for receiving a handle of the drywall texturing gun.

2. The holder according to claim 1, wherein said rack is generally shaped as a ladder with two steps, with a first one of the horizontal support members being located closer to a first end of the rack than a second one of the horizontal support members is located to a second end of the rack.

3. The holder according to claim 1, wherein said upright support members and said horizontal support members are metal rods welded together in a single integral unit.

4. The holder according to claim 1, wherein the base structure is a channel structure having a web with an upper planar surface and flanges extending downwardly from opposite sides of the web for supporting the base structure on a floor surface.

5. The holder according to claim 4, wherein said base structure has embedded sockets for receiving respective ends of the upright support members.

6. The holder according to claim 5, wherein said sockets extend through the web and are secured along respective inner sides of the flanges.

7. The holder according to claim 4, wherein said base structure is fiberglass, and said sockets comprise metal tubes embedded in the fiberglass.

8. The holder according to claim 1, wherein the receptacle has an open top.

9. The holder according to claim 8, wherein said receptacle is a cylindrical structure with a closed bottom, and the receptacle is mounted to the base structure by a threaded fastener extending through a hole in the closed bottom and a corresponding hole in the base structure.

10. The holder according to claim 1, wherein the rack and the receptacle are removable from the base structure and can be stowed within a channel of the base structure for compact storage and shipping.

11. The holder according to claim 1, wherein the rack, when removed, can be stored within the base structure to form a compact, rectangular cuboid configuration suitable for standard shipping boxes.

12. The holder according to claim 1, wherein the sockets are angled so that the rack leans toward the drywall texturing gun during use.

13. The holder according to claim 1, wherein the horizontal support members provide different resting heights for accommodating texturing guns in both wall and ceiling spraying configurations.

14. The holder according to claim 1, wherein the sockets extend at an angle of about 10 degrees to about 30 degrees from vertical.

15. The holder according to claim 1, wherein the rack is reversible to provide a convertible configuration allowing the rack to be repositioned for different texturing applications.

16. The holder according to claim 1, wherein reversing the rack relative to the base structure provides different support heights for accommodating the drywall texturing gun in ceiling-spraying and wall-spraying configurations.

17. A holder for a drywall texturing gun, comprising:
a base structure;
a rack having two upright support members and first and second horizontal support members fixed together as a unit, the upright support members having lower end portions removably receivable by the base structure, the rack being reversible end-for-end relative to the base structure so that, in a first orientation, the first horizontal support member is positioned to support a portion of the drywall texturing gun and, in a second orientation, the second horizontal support member is positioned to support a portion of the drywall texturing gun;
wherein said rack is generally shaped as a ladder with two steps, with the first one of the horizontal support members being located closer to a first end of the rack than the second horizontal support member is located to a second end of the rack;
wherein reversing the rack relative to the base structure provides different support heights for accommodating the drywall texturing gun in ceiling-spraying and wall-spraying configurations;
wherein the sockets are angled so that the rack leans toward the drywall texturing gun during use; and
further comprising a receptacle on the base structure for receiving a handle of the drywall texturing gun.
